(19) United States
(12) Patent Application Publication
(10) Pub. No.: US 2022/0314343 A1
(43) Pub. Date: Oct. 6, 2022

(54) TOOL BIT, A TOOLING ASSEMBLY FOR APPLYING A FLUID TO A SURFACE, AND A METHOD

(71) Applicant: The Boeing Company, Chicago, IL (US)

(72) Inventors: Monica J. Brockway, Bothell, WA (US); Farahnaz Sisco, Mukilteo, WA (US)

(73) Assignee: The Boeing Company, Chicago, IL (US)

(21) Appl. No.: 17/845,286

(22) Filed: Jun. 21, 2022

Related U.S. Application Data
(62) Division of application No. 16/827,793, filed on Mar. 24, 2020.

(51) Int. Cl. B23B 51/06

(52) U.S. Cl. CPC B23B 51/06; B23B 2250/12; B23B 51/02

(57) ABSTRACT

A tool bit includes a body having an internal cavity extending along a longitudinal axis between a first distal end and a second distal end. A plurality of channels of the body extend transverse from the internal cavity of the body. The first distal end includes an inlet in fluid communication with the internal cavity and the plurality of channels. The body includes an outer surface having a plurality of outlets spaced from the second distal end. Each one of the plurality of outlets is in fluid communication with a corresponding one of the plurality of channels such that a fluid is deliverable into the body via the inlet and out of the body via the plurality of outlets. A tooling assembly for applying a fluid to a surface includes a workpiece and the tool bit as discussed above which is movable relative to the workpiece.

### CROSS-REFERENCE TO RELATED APPLICATIONS

This application is a divisional of U.S. patent application Ser. No. 16/827,793 filed on Mar. 24, 2020, which is hereby incorporated by reference in its entirety.

### BACKGROUND

During manufacturing of a workpiece, the workpiece may be drilled to create a hole therethrough. A drill bit having a cutting tip may be used to drill the hole through the workpiece. A fluid may be applied to the workpiece as the hole is being created to remove debris from the hole and/or to lubricate cutting surfaces of the workpiece. To deliver the fluid during cutting, the drill bit includes a center aperture that intersects the cutting tip, and the fluid is delivered to the cutting surfaces via the cutting tip.

### SUMMARY

Therefore, there is a need for a tool bit design that delivers a fluid to a workpiece from a location away from a tip of the tool bit.

The present disclosure provides a tool bit that includes a body. The body includes an internal cavity extending along a longitudinal axis between a first distal end of the body and a second distal end of the body. A plurality of channels of the body extend transverse from the internal cavity of the body. The first distal end includes an inlet in fluid communication with the internal cavity and the plurality of channels. The body includes an outer surface having a plurality of outlets spaced from the second distal end. Each one of the plurality of outlets is in fluid communication with a corresponding one of the plurality of channels such that a fluid is deliverable into the body via the inlet and out of the body via the plurality of outlets.

The present disclosure also provides a tooling assembly for applying a fluid to a surface. The tooling assembly includes a workpiece and a tool bit movable relative to the workpiece. The workpiece includes an aperture, and the surface defines a boundary of the aperture. The tool bit includes a body. The body includes an internal cavity extending along a longitudinal axis between a first distal end of the body and a second distal end of the body. A plurality of channels of the body extend transverse from the internal cavity of the body. The first distal end includes an inlet in fluid communication with the internal cavity and the plurality of channels. The body includes an outer surface having a plurality of outlets spaced from the second distal end. Each one of the plurality of outlets is in fluid communication with a corresponding one of the plurality of channels such that a fluid is deliverable into the body via the inlet and out of the body via the plurality of outlets.

The present disclosure further provides a method of applying a fluid to a surface of a workpiece. The surface defines a boundary of an aperture of the workpiece. A shank portion of a tool bit is coupled to an end effector such that an applicator portion of the tool bit is spaced from the end effector. The tool bit is inserted into the aperture of the workpiece until a plurality of outlets of the applicator portion is positioned to face the surface of the workpiece at a start location. The fluid is delivered through an internal cavity of the tool bit, through a plurality of channels of the tool bit, and out of the plurality of outlets to apply the fluid to the surface of the workpiece at the start location. The plurality of channels extends from the internal cavity, and each one of the plurality of outlets is in fluid communication with a corresponding one of the plurality of channels.

The detailed description and the drawings or figures are supportive and descriptive of the disclosure, but the claim scope of the disclosure is defined solely by the claims. While some of the best modes and other configurations for carrying out the claims have been described in detail, various alternative designs and configurations exist for practicing the disclosure defined in the appended claims.

### BRIEF DESCRIPTION OF THE DRAWINGS

FIG. 1 is a schematic illustration of one configuration of a tool bit that is cutting a workpiece to create an aperture in the workpiece.

FIG. 2 is a schematic illustration of the tool bit of FIG. 1 that is located within the aperture to apply a fluid to a surface of the workpiece as the tool bit is retracted from the aperture.

FIG. 3 is a schematic illustration of another configuration of a tool bit that is located within the aperture and is applying the fluid to the surface of the workpiece as the tool bit is retracted from the aperture.

FIG. 4 is a schematic side view of the tool bit suitable for FIGS. 1 and 2 and illustrating a plurality of channels in a first orientation in hidden lines.

FIG. 5 is a schematic cross-sectional view of the tool bit of FIG. 4 taken along lines 5-5 of FIG. 4.

FIG. 6 is a schematic side view of a tool bit suitable for FIGS. 1 and 2 and illustrating a plurality of channels in a second orientation in hidden lines.

FIG. 7 is a schematic cross-sectional view of the tool bit of FIG. 6 taken along lines 7-7 of FIG. 6.

FIG. 8 is a schematic side view of a tool bit suitable for FIG. 3 and illustrating a pair of channels in a first orientation in hidden lines.

FIG. 9 is a schematic cross-sectional view of the tool bit of FIG. 8 taken along lines 9-9 of FIG. 8.

FIG. 10 is a schematic side view of a tool bit compatible with FIG. 3 and illustrating a pair of channels in a second orientation in hidden lines.

FIG. 11 is a schematic cross-sectional view of the tool bit of FIG. 10 taken along lines 11-11 of FIG. 10.

The present disclosure may be extended to modifications and alternative forms, with representative configurations shown by way of example in the drawings and described in detail below. Inventive aspects of the disclosure are not limited to the disclosed configurations. Rather, the present disclosure is intended to cover modifications, equivalents, combinations, and alternatives falling within the scope of the disclosure as defined by the appended claims.

### DETAILED DESCRIPTION

Those having ordinary skill in the art will recognize that all directional references (e.g., above, below, upward, up, downward, down, top, bottom, left, right, vertical, horizontal, etc.) are used descriptively for the figures to aid the reader's understanding, and do not represent limitations (for example, to the position, orientation, or use, etc.) on the scope of the disclosure, as defined by the appended claims.

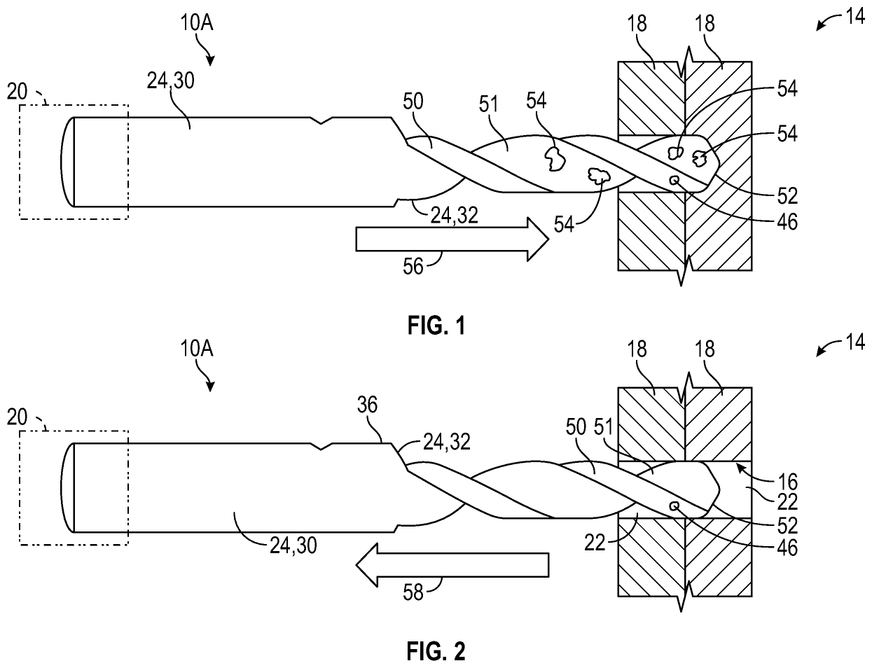

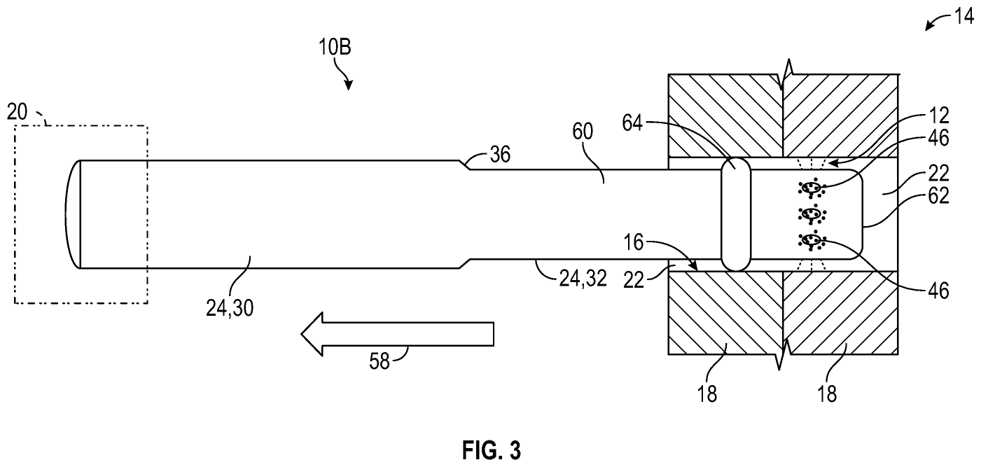

Referring to the figures, wherein like numerals indicate like or corresponding parts throughout the several views, a tool bit 10A, 10B is generally shown in FIGS. 1-3. As will be discussed in detail below, the tool bit 10A, 10B may accurately apply a fluid 12 to a desired location. The tool bit 10A, 10B may have different configurations depending on the desired application. For example, FIGS. 1, 2, 4, and 6 illustrates the tool bit 10A, 10B as a drill bit 10A and as another example, FIGS. 3, 8, and 10 illustrates the tool bit 10A, 10B as a lubricator bit 10B, both of which will be discussed further below. It is to be appreciated that FIGS. 1-4, 6, 8, and 10 are non-limiting examples of different suitable configurations of the tool bit 10A, 10B.

Referring to FIGS. 1-3, the present disclosure provides a tooling assembly 14 for applying the fluid 12 to a surface 16. The surface 16 may be part of a workpiece 18, and the tool bit 10A, 10B is movable relative to the workpiece 18. The tool bit 10A, 10B is configured to deliver the fluid 12 to a desired location of the workpiece 18, which may be performed via an automated process. By automating the process, an accurate amount of the fluid 12 may be delivered to the workpiece 18. In addition, by automating the process, accurate placement of the fluid 12 relative to the workpiece 18 may be achieved. Therefore, excess application of the fluid 12 does not occur in this process, which thus, minimizes waste of the fluid 12.

The tooling assembly 14 may include the tool bit 10A, 10B, the workpiece 18, and an end effector 20 (schematically shown in FIGS. 1-3) that supports and moves the tool bit 10A, 10B relative to the workpiece 18. The end effector 20 may be controlled via a robot or any other automated machine or component. In certain configurations, the end effector 20 is part of a drill, and the drill operates to rotate the drill bit 10A which cuts the workpiece 18.

The workpiece 18 may include an aperture 22, and in certain configurations, the surface 16 defines a boundary of the aperture 22. The aperture 22 may be completely through the workpiece 18 or the aperture 22 may be partially through the workpiece 18, i.e., a blind bore. As such, the tool bit 10A, 10B as described herein is configured to accurately apply the fluid 12 to the surface 16 inside the aperture 22 at the desired location of the workpiece 18.

The workpiece 18 may be any suitable configuration, and non-limiting examples may include one or more of: a panel, a sheet, a frame, a beam, a bracket, etc. Furthermore, the workpiece 18 may be used in any suitable structure, and non-limiting examples may include an aircraft, a vehicle, a watercraft, a stationary unit, a robot, a powerplant, a movable platform, a building, a consumer product, an infrastructure, etc. In addition, the workpiece 18 may include one structure or a plurality of structures as shown in FIGS. 1-3.

One or more reservoirs may be used to contain the fluid 12 and one or more corresponding supply lines may be coupled to the reservoir and the tool bit 10A, 10B to deliver the fluid 12 through the tool bit 10A, 10B and to the surface 16 of the workpiece 18. A controller may control movement of the end effector 20 and/or control delivery of the fluid 12 (the amount and/or the location) from the reservoirs to the tool bit 10A, 10B. FIG. 3 illustrates the fluid 12 being sprayed toward the surface 16 for illustrative purposes. It is to be appreciated that the fluid 12 is sprayed in a similar manner in FIG. 2 even though the fluid 12 is not shown in this figure. In various configurations, the fluid 12 is a liquid. In other configurations, the fluid 12 is a combination of liquid and gas. When the fluid 12 is a combination of liquid and gas, the mixture may be atomized. The liquid may be a lubricant, an oil, etc. The gas may be air, etc.

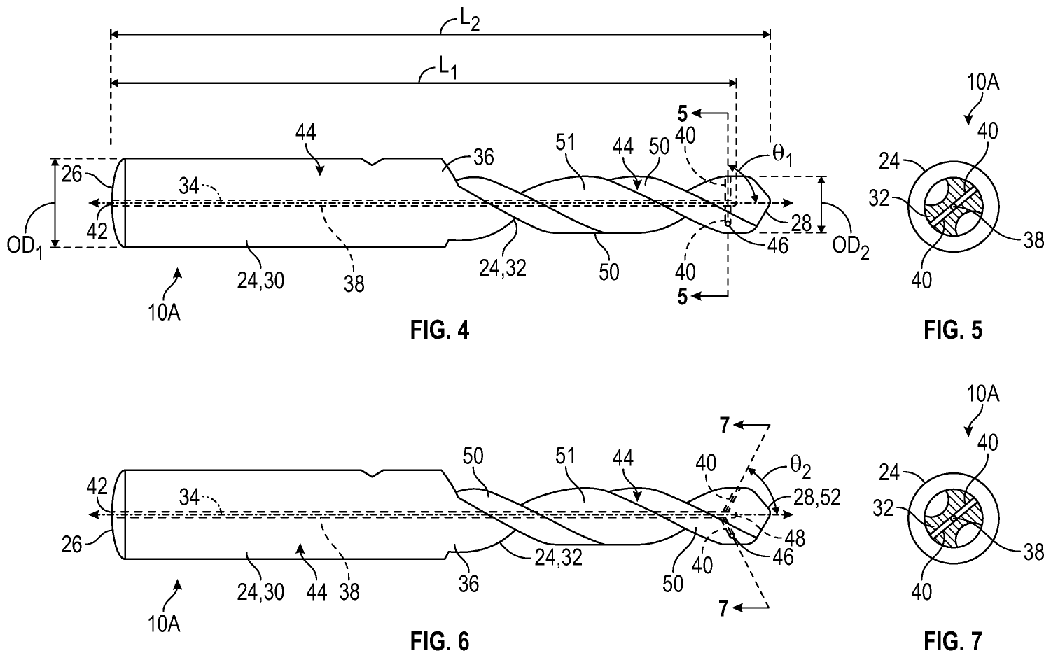

Referring to FIGS. 4, 6, 8, and 10, the tool bit 10A, 10B includes a body 24 having a first distal end 26 and a second distal end 28. As shown by comparing FIGS. 4, 6, 8, and 10, the body 24 may be various configurations depending on the desired application of the tool bit 10A, 10B. Generally, the body 24 may include a shank portion 30 and an applicator portion 32. The shank portion 30 and the applicator portion 32 are disposed adjacent to each other. More specifically, the shank portion 30 and the applicator portion 32 are connected to each other and extend along a longitudinal axis 34 between the first distal end 26 and the second distal end 28. In certain configurations, the shank portion 30 has an outer diameter OD₁ that is greater than an outer diameter OD₂ of the applicator portion 32. Therefore, for example, the shank portion 30 and the applicator portion 32 transition at a step 36 (numbered only in FIG. 10). The step 36 may provide a limit that the tool bit 10A, 10B may be inserted into the workpiece 18.

The shank portion 30 of the tool bit 10A, 10B is coupled to the end effector 20 such that the end effector 20 may support and move the tool bit 10A, 10B. Furthermore, the applicator portion 32 applies the fluid 12 to the desired location of the workpiece 18. Therefore, movement of the end effector 20 causes movement of the tool bit 10A, 10B, and thus, movement of the applicator portion 32 into and out of the aperture 22 of the workpiece 18 to the desired location to apply the fluid 12.

Referring to FIGS. 4, 6, 8, and 10, generally, the body 24 includes an internal cavity 38 extending along the longitudinal axis 34 between the first distal end 26 of the body 24 and the second distal end 28 of the body 24. In certain configurations, the first distal end 26 is disposed at an end of the shank portion 30 and the second distal end 28 is disposed at an end of the applicator portion 32. The internal cavity 38 may be disposed inside the shank portion 30 and the applicator portion 32.

Continuing with FIGS. 4, 6, 8, and 10, a plurality of channels 40 of the body 24 extends transverse from the internal cavity 38 of the body 24. That is, the body 24 includes the plurality of channels 40 that extend from the internal cavity 38 transverse to the longitudinal axis 34, and the plurality of channels 40 are in fluid 12 communication with the internal cavity 38. In certain configurations, the plurality of channels 40 are disposed inside of the applicator portion 32 of the body 24, and thus, the plurality of channels 40 are spaced from the shank portion 30 of the body 24.

In certain configurations, the internal cavity 38 is further defined as a plurality of internal cavities 38 disposed inside of the body 24. In this configuration, each of the plurality of internal cavities 38 are configured as described herein for the single internal cavity 38 except that the plurality of internal cavities 38 are spaced from each other. Furthermore, one or more of the plurality of channels 40 may extend transverse from one of the plurality of internal cavities 38, and one or more of the plurality of channels 40 may extend transverse from another one of the plurality of internal cavities 38. In various configurations, one of the plurality of internal cavities 38 may deliver one type of the fluid 12 to the surface 16, and the other one of the plurality of internal cavities 38 may deliver another type of the fluid 12 to the surface 16. In other configurations, each of the plurality of internal cavities 38 may deliver the same type of the fluid 12 to the surface 16.

Referring to FIGS. 4, 6, 8, and 10, the first distal end 26 includes an inlet 42 in fluid 12 communication with the internal cavity 38 and the plurality of channels 40. In certain configurations, the shank portion 30 may include the inlet 42. The inlet 42 provides a location to deliver the fluid 12 into the body 24, and more specifically, to deliver the fluid 12 into the internal cavity 38.

Referring to FIGS. 1-4, 6, 8, and 10, the body 24 includes an outer surface 44 having a plurality of outlets 46 spaced from the second distal end 28. Generally, the first distal end 26 and the second distal end 28 are disposed transverse to the outer surface 44 of the body 24. That is, the outer surface 44 surrounds the longitudinal axis 34, and the longitudinal axis 44 intersects the first distal end 26 and the second distal end 28.

The plurality of outlets 46 provide a plurality of locations to deliver the fluid 12 to the desired location of the workpiece 18. Each one of the plurality of outlets 46 is in fluid 12 communication with a corresponding one of the plurality of channels 40 such that the fluid 12 is deliverable into the body 24 via the inlet 42 and out of the body 24 via the plurality of outlets 46. In certain configurations, the applicator portion 32 may include the plurality of outlets 46.

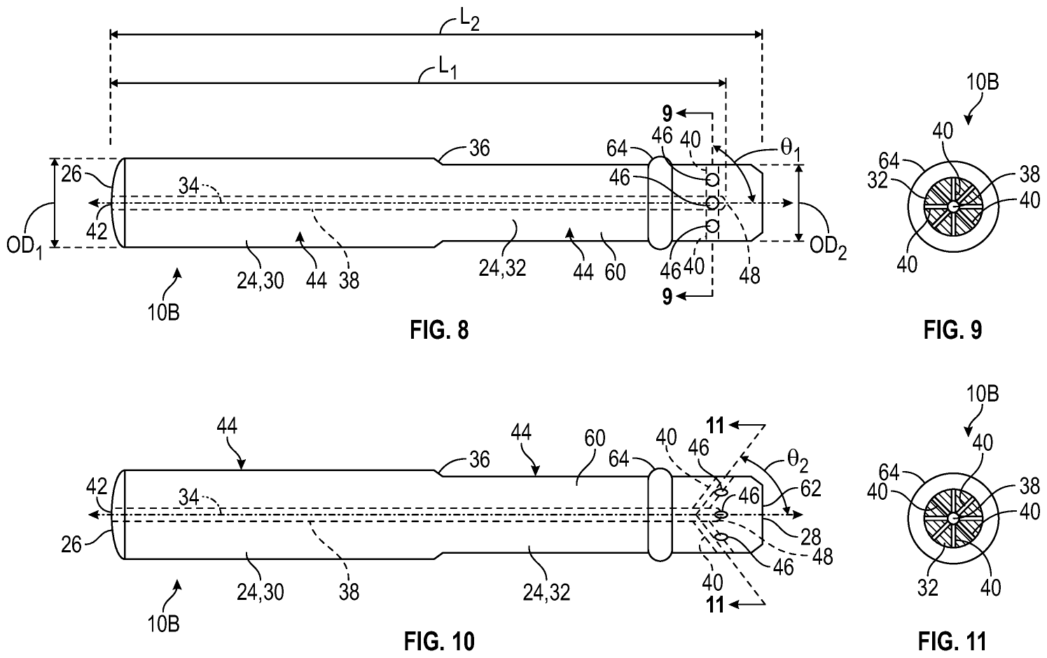

The plurality of channels 40 may extend from the internal cavity 38 in various orientations. For example, as best shown in FIGS. 4 and 8, the plurality of channels 40 extends perpendicularly relative to the longitudinal axis 34. That is, the plurality of channels 40 may extend at an angle Θ₁ of about ninety degrees relative to the longitudinal axis 34. As another example, as best shown in FIGS. 6 and 10, the plurality of channels 40 extends at an angle Θ₂ greater than zero degrees and less than ninety degrees relative to the longitudinal axis 34. That is, in certain configurations, the plurality of channels 40 extends from the internal cavity 38 at an acute angle relative to the longitudinal axis 34 (again see FIGS. 6 and 10). As one non-limiting example, the angle Θ₂ of the plurality of channels 40 may be about thirty degrees to about sixty degrees relative to the longitudinal axis 34. It is to be appreciated that two of the plurality of channels 40 are illustrated in hidden lines in FIGS. 4, 6, 8, and 10 to illustrate the example orientations of the plurality of channels 40 relative to the internal cavity 38; and it is to be appreciated that each of the plurality of channels 40 are at the same orientation relative to the internal cavity 38 for those respective example orientations even though hidden lines are not provided for all of the plurality of channels 40.

Referring to FIGS. 4, 6, 8, and 10, generally, the internal cavity 38 does not intersect the second distal end 28. That is, the internal cavity 38 is spaced from the second distal end 28. Therefore, the fluid 12 does not exit the tool bit 10A, 10B via the second distal end 28. As such, the internal cavity 38 terminates at an end wall 48 that is spaced from the second distal end 28. The plurality of channels 40 branches from the internal cavity 38 away from the end wall 48. Furthermore, the plurality of channels 40 are disposed proximal to the end wall 48.

Referring to FIGS. 4 and 8, the internal cavity 38 extends a first length L₁ along the longitudinal axis 34. Generally, the first length L₁ of the internal cavity 38 is measured between the first distal end 26 and the end wall 48. The body 24 extends a second length L₂ along the longitudinal axis 34. Generally, the second length L₂ is measured between the first distal end 26 and the second distal end 28. The first length L₁ is less than the second length L₂ such that the internal cavity 38 is spaced from the second distal end 28. Again, the internal cavity 38 does not intersect the second distal end 28 such that the fluid 12 does not exit the second distal end 28.

As mentioned above, the tool bit 10A, 10B may be different configurations depending on the desired application. Two examples of the tool bit 10A, 10B will be detailed next. Turning to FIGS. 1, 2, and 4-7, the tool bit 10A is the drill bit 10A, which creates the aperture 22 in the workpiece 18 and applies the desired amount of the fluid 12 to the surface 16 inside the aperture 22 at the desired location. Therefore, by incorporating two functions, i.e., cutting and application of the fluid 12, into the drill bit 10A, efficiencies may be gained due to the shorter cycle times.

In the configuration of FIGS. 1, 2, and 4-7, the applicator portion 32 includes a cutter 50, 51, 52 having a plurality of lands 50. In addition, the cutter 50, 51, 52 may include a plurality of flutes 51 adjacent to the plurality of lands 50. The plurality of flutes 51 are recessed toward the longitudinal axis 34 to present a channel that guides flakes 54 (see FIG. 1) away from the second distal end 28. The plurality of lands 50 present a face along the outer surface 44, and the plurality of lands 50 are spaced farther from the longitudinal axis 34 than the plurality of flutes 51. The plurality of lands 50 face the surface 16 of the workpiece 18 when the drill bit 10A is disposed inside the aperture 22.

Continuing with FIGS. 1, 2, and 4-7, the cutter 50, 51, 52 may include a cutting tip 52 at the second distal end 28, and the plurality of lands 50 are spaced from the second distal end 28. That is, the plurality of lands 50 are spaced from the cutting tip 52. Furthermore, the plurality of flutes 51 are spaced from the second distal end 28, and thus, spaced from the cutting tip 52. The cutting tip 52 is configured to cut through the workpiece 18 to create the aperture 22 as shown in FIG. 1, and the plurality of flutes 51 are configured to remove the flakes 54 (again see FIG. 1) of the workpiece 18 due to cutting the aperture 22. The arrow 56 indicates the direction that the drill bit 10A moves to cut the workpiece 18 in this configuration.

Continuing with FIGS. 1, 2, and 4-7, the plurality of outlets 46 are spaced from the cutting tip 52. That is, the cutting tip 52 is characterized by the absence of the plurality of outlets 46. Each one of the plurality of outlets 46 is disposed through a corresponding one of the plurality of lands 50. Therefore, after cutting the workpiece 18 via the drill bit 10A, the plurality of outlets 46 along the plurality of lands 50 may apply the fluid 12 to the surface 16. As such, the plurality of outlets 46 along the plurality of lands 50 face the surface 16 of the workpiece 18 when the applicator portion 32 is disposed in the aperture 22 such that the fluid 12 is directed toward the surface 16 of the workpiece 18. The arrow 58 indicates the direction that the drill bit 10A moves to apply the fluid 12 to the surface 16 inside the aperture 22 in this configuration.

Turning to FIGS. 3 and 8-11, the tool bit 10B is the lubricator bit 10B, which is used after creating the aperture 22 in the workpiece 18 and applies the desired amount of the fluid 12 to the surface 16 inside the aperture 22 at the desired location. The lubricator bit 10B also provides flexibility for other operations such as diameter inspection of the aperture 22. In addition, the lubricator bit 10B may be used in situations where the drill bit 10A cannot be used, such as when the outer diameter OD₁, OD₂ of the drill bit 10A is too small to include the internal cavity 38. In this configuration, the applicator portion 32 includes a rod 60 having a bullet-nosed tip 62 at the second distal end 28. Generally, the bullet-nosed tip 62 may be blunt and/or may have a lead-in edge. The outer surface 44 presents a circular configuration that surrounds the longitudinal axis 34, and thus, the outer surface 44 that presents the circular configuration does not include the configuration of the second distal end 28 which is transverse to the outer surface 44. The second distal end 28 in this configuration is the bullet-nosed tip 62.

Continuing with FIGS. 3 and 8-11, each of the plurality of outlets 46 are spaced from the bullet-nosed tip 62. That is the bullet-nosed tip 62 is characterized by the absence of the plurality of outlets 46. In certain configurations, the plurality of outlets 46 are defined through the circular configuration along the rod 60. Therefore, the plurality of outlets 46 along the rod 60 may apply the fluid 12 to the surface 16. The plurality of outlets 46 around the outer surface 44 of the rod 60 face the surface 16 of the workpiece 18 when the applicator portion 32 is disposed in the aperture 22 such that the fluid 12 is directed toward the surface 16 of the workpiece 18.

As best shown in FIG. 3, optionally, a seal 64 may be disposed around the applicator portion 32. The seal 64 may engage the outer surface 44 of the rod 60 and the surface 16 of the workpiece 18 to prevent the fluid 12 from reaching a portion of the surface 16 of the workpiece 18.

The present disclosure also provides a method of applying the fluid 12 to the surface 16 of the workpiece 18. As mentioned above, the surface 16 defines the boundary of the aperture 22 of the workpiece 18.

The shank portion 30 of the tool bit 10A, 10B is coupled to the end effector 20 such that the applicator portion 32 of the tool bit 10A, 10B is spaced from the end effector 20. The tool bit 10A, 10B is inserted into the aperture 22 of the workpiece 18 until the plurality of outlets 46 of the applicator portion 32 is positioned to face the surface 16 of the workpiece 18 at a start location. For example, FIGS. 2 and 3 may represent the start location. The fluid 12 is delivered through the internal cavity 38 of the tool bit 10A, 10B, through the plurality of channels 40 of the tool bit 10A, 10B, and out of the plurality of outlets 46 to apply the fluid 12 to the surface 16 of the workpiece 18 at the start location. As mentioned above, the plurality of channels 40 extends from the internal cavity 38, and each one of the plurality of outlets 46 is in fluid 12 communication with a corresponding one of the plurality of channels 40. As such, the fluid 12 may be applied to multiple locations of the surface 16 due to the plurality of outlets 46.

Generally, the tool bit 10A, 10B is moved from the start location within the aperture 22 to a final location outside of the aperture 22. The tool bit 10A, 10B moves in the direction of the arrow 58 (see FIGS. 2 and 3) until the final location is reached outside of the aperture 22. In certain configurations, the fluid 12 is delivered to the surface 16 after the tool bit 10A, 10B reaches the start location and while the tool bit 10A, 10B moves toward the final location. In certain configurations, delivery of the fluid 12 may be stopped prior to the tool bit 10A, 10B exiting the aperture 22 and reaching the final location outside of the workpiece 18. In other configurations, delivery of the fluid 12 may be stopped as the tool bit 10A, 10B exits the aperture 22 to the final location such that some of the fluid 12 may be applied to an outer edge of the workpiece 18 adjacent to the aperture 22. Delivery of the fluid 12 may be continuous, intermittent, periodic, etc. Therefore, for example, the fluid 12 may be delivered periodically to the surface 16 during movement of the tool bit 10A, 10B between the start location and the final location. As another example, the fluid 12 may be delivered continuously to the surface 16 during movement of the tool bit 10A, 10B between the start location and the final location.

If the tool bit 10A is the drill bit 10A, the aperture 22 is created in the workpiece 18 via the drill bit 10A as the drill bit 10A moves in the direction of arrow 56 in FIG. 1. Therefore, in this configuration, the workpiece 18 is cut via the cutting tip 52 of the cutter 50, 51, 52 of the applicator portion 32 to create the aperture 22 and the surface 16. The flakes 54 of the workpiece 18 are removed via the plurality of flutes 51 of the cutter 50, 51, 52 as the cutting tip 52 cuts the workpiece 18. For example, rotation of the plurality of the flutes 51 guides the flakes 54 out of the aperture 22.

Optionally, during cutting of the workpiece 18 via the drill bit 10A, the fluid 12 may be delivered out of the plurality of outlets 46. The fluid 12 delivered during cutting may include one or more of a lubricant, oil, air, coolant, etc. If the fluid 12 is applied during cutting, then after cutting, the same fluid 12 may optionally be applied to lubricate the surface 16 of the workpiece 18. Alternatively, the fluid 12 applied during cutting may be different from the fluid 12 applied to lubricate the surface 16 of the workpiece 18 after cutting is completed. For example, during cutting, the fluid 12 may be coolant, and after cutting, the fluid 12 may be atomized oil.

In certain configurations, the fluid 12 is delivered after cutting the workpiece 18 and removing the flakes 54. Therefore, once the aperture 22 is created, the fluid 12 may be applied to the surface 16 in the desired amount and the desired location via the drill bit 10A. Again, as mentioned above, each one of the plurality of outlets 46 is disposed through a corresponding one of the plurality of lands 50 which are disposed adjacent to the plurality of flutes 51. As also mentioned above, the plurality of outlets 46 are spaced from the cutting tip 52. As such, the fluid 12 exits the plurality of outlets 46 along the plurality of the lands 50 as the drill bit 10A moves toward the final location. The drill bit 10A may be rotating as the fluid 12 exits the plurality of outlets 46, or the drill bit 10A may not be rotating as the fluid 12 exits the plurality of outlets 46. Regardless of whether the drill bit 10A is rotating, the drill bit 10A moves in the direction of the arrow 58 until the final location is reached.

If the tool bit 10B is the lubricator bit 10B, the aperture 22 is predrilled into the workpiece 18. That is, the lubricator bit 10B is used post drilling of the aperture 22. Therefore, in this configuration, the lubricator bit 10B is not used until after the aperture 22 is formed in the workpiece 18. The rod 60 of the applicator portion 32 is inserted into the aperture 22 of the workpiece 18 in the direction of the arrow 56 until the outer surface 44 of the body 24 along the rod 60 faces the surface 16 of the workpiece 18 in the start location. Again, as mentioned above, the plurality of outlets 46 are defined through the outer surface 44 and the plurality of outlets 46 are spaced from the bullet-nosed tip 62 of the rod 60. As such, the fluid 12 exits the plurality of outlets 46 along the rod 60 as the lubricator bit 10B moves toward the final location. The lubricator bit 10B may be rotating as the fluid 12 exits the plurality of outlets 46, or the lubricator bit 10B may not be rotating as the fluid 12 exits the plurality of outlets 46. Regardless of whether the lubricator bit 10B is rotating, the lubricator bit 10B moves in the direction of the arrow 58 until the final location is reached. If using the seal 64, the seal 64 engages the surface 16 of the workpiece 18 to prevent the fluid 12 from reaching a certain portion of the surface 16 of the workpiece 18 during the operation of the lubricator bit 10B.

It is to be appreciated that the order or sequence of performing the method as described herein is for illustrative purposes and other orders or sequences are within the scope of the present teachings. It is to also be appreciated that the method can include other features not specifically discussed in the paragraphs above.

Aspects of the present disclosure have been described in detail with reference to the illustrated embodiments. Those skilled in the art will recognize, however, that certain modifications may be made to the disclosed structure and/or methods without departing from the scope of the present disclosure. The disclosure is also not limited to the precise construction and compositions disclosed herein. Modifications apparent from the foregoing descriptions are within the scope of the disclosure as defined by the appended claims. Moreover, the present concepts expressly include combinations and sub-combinations of the preceding elements and features.

What is claimed is:

1. A tool bit comprising:
a body including an internal cavity extending along a longitudinal axis between a first distal end of the body and a second distal end of the body; and
a plurality of channels of the body extending transverse from the internal cavity of the body;
wherein the first distal end includes an inlet in fluid communication with the internal cavity and the plurality of channels;
wherein the body includes an outer surface having a plurality of outlets spaced from the second distal end, and each one of the plurality of outlets is in fluid communication with a corresponding one of the plurality of channels such that a fluid is deliverable into the body via the inlet and out of the body via the plurality of outlets.

2. The tool bit as set forth in claim 1 wherein the plurality of channels extends perpendicularly relative to the longitudinal axis.

3. The tool bit as set forth in claim 1 wherein the plurality of channels extends at an angle greater than zero degrees and less than ninety degrees relative to the longitudinal axis.

4. The tool bit as set forth in claim 1 wherein the internal cavity terminates at an end wall that is spaced from the second distal end, and wherein the plurality of channels branches from the internal cavity away from the end wall.

5. The tool bit as set forth in claim 1 wherein the internal cavity extends a first length along the longitudinal axis, and the body extends a second length along the longitudinal axis, and wherein the first length is less than the second length such that the internal cavity is spaced from the second distal end.

6. The tool bit as set forth in claim 1 wherein:
the body further includes a shank portion and an applicator portion;
the shank portion and the applicator portion are connected to each other and extend along the longitudinal axis between the first distal end and the second distal end; and
the shank portion has an outer diameter that is greater than an outer diameter of the applicator portion.

7. The tool bit as set forth in claim 6 wherein the applicator portion includes a cutter having a plurality of lands, and wherein each one of the plurality of outlets is disposed through a corresponding one of the plurality of lands.

8. The tool bit as set forth in claim 7 wherein the cutter includes a cutting tip at the second distal end, and the plurality of outlets are spaced from the cutting tip.

9. The tool bit as set forth in claim 8 wherein the tool bit is a drill bit.

10. A tooling assembly for applying a fluid to a surface, the tooling assembly comprising:
a workpiece includes an aperture, and the surface defines a boundary of the aperture; and
a tool bit movable relative to the workpiece, the tool bit includes:
a body including an internal cavity extending along a longitudinal axis between a first distal end of the body and a second distal end of the body; and
a plurality of channels of the body extending transverse from the internal cavity of the body;
wherein the first distal end includes an inlet in fluid communication with the internal cavity and the plurality of channels;
wherein the body includes an outer surface having a plurality of outlets spaced from the second distal end, and each one of the plurality of outlets is in fluid communication with a corresponding one of the plurality of channels such that a fluid is deliverable into the body via the inlet and out of the body via the plurality of outlets.

11. The tooling assembly as set forth in claim 10 wherein the plurality of channels extends perpendicularly relative to the longitudinal axis.

12. The tooling assembly as set forth in claim 10 wherein the plurality of channels extends at an angle greater than zero degrees and less than ninety degrees relative to the longitudinal axis.

13. The tooling assembly as set forth in claim 10 wherein the internal cavity terminates at an end wall that is spaced from the second distal end, and wherein the plurality of channels branches from the internal cavity away from the end wall.

14. The tooling assembly as set forth in claim 10 wherein the internal cavity extends a first length along the longitudinal axis, and the body extends a second length along the longitudinal axis, and wherein the first length is less than the second length such that the internal cavity is spaced from the second distal end.

15. A method of applying a fluid to a surface of a workpiece, wherein the surface defines a boundary of an aperture of the workpiece, the method comprising:
coupling a shank portion of a tool bit to an end effector such that an applicator portion of the tool bit is spaced from the end effector;
inserting the tool bit into the aperture of the workpiece until a plurality of outlets of the applicator portion is positioned to face the surface of the workpiece at a start location; and
delivering the fluid through an internal cavity of the tool bit, through a plurality of channels of the tool bit, and out of the plurality of outlets to apply the fluid to the surface of the workpiece at the start location, wherein the plurality of channels extends from the internal cavity, and each one of the plurality of outlets is in fluid communication with a corresponding one of the plurality of channels.

16. The method as set forth in claim 15:
further comprising moving the tool bit from the start location within the aperture to a final location outside of the aperture; and
wherein delivering the fluid further comprises delivering the fluid to the surface after the tool bit reaches the start location and while the tool bit moves toward the final location.

17. The method as set forth in claim 16 wherein delivering the fluid further comprises delivering the fluid periodically to the surface during movement of the tool bit between the start location and the final location.

18. The method as set forth in claim 16 wherein delivering the fluid further comprises delivering the fluid continuously to the surface during movement of the tool bit between the start location and the final location.

19. The method as set forth in claim 15:
further comprising cutting the workpiece via a cutting tip of a cutter of the applicator portion to create the aperture and the surface;
further comprising removing flakes of the workpiece via a plurality of flutes of the cutter as the cutting tip cuts the workpiece, and wherein each one of the plurality of outlets is disposed through a corresponding one of a plurality of lands which are disposed adjacent to the plurality of flutes, and the plurality of outlets are spaced from the cutting tip; and
wherein delivering the fluid further comprises delivering the fluid after cutting the workpiece and removing the flakes.
